(19) United States
(12) Patent Application Publication
(10) Pub. No.: US 2010/0085508 A1
(43) Pub. Date: Apr. 8, 2010

(54) DISPLAY PANEL AND LIQUID CRYSTAL DISPLAY HAVING THE SAME

(75) Inventors: Min KANG, Seoul (KR); Se-Ah KWON, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/570,455

(22) Filed: Sep. 30, 2009

(30) Foreign Application Priority Data
Oct. 8, 2008 (KR) 10-2008-0098722

(51) Int. Cl. G02F 1/13357; G02F 1/1335

(52) U.S. Cl. 349/64; 349/96

(57) ABSTRACT

A display panel includes; a first substrate including glass and having at least one unpolished surface, a second substrate disposed substantially opposite to the first substrate, a liquid crystal layer interposed between the first substrate and the second substrate, a first polarizing plate disposed on an outer surface of the first substrate and including a diffusion layer, and a second polarizing plate disposed on an outer surface of the second substrate.

This application claims priority to Korean Patent Application No. 10-2008-0098722, filed on Oct. 8, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display panel and a liquid crystal display (“LCD”) having the same, and more particularly, to a display panel without mura patterns appearing on a screen despite using an unpolished glass substrate, and an LCD having the display panel.

2. Description of the Related Art

As the modern society changes into an information-oriented society, market demand for display devices having a large-screen size and a slim profile is increasing. To overcome the disadvantages of conventional Cathode Ray Tubes (“CRTs”), there is an explosively growing demand for flat display devices, examples of which include a Plasma Display Panel (“PDP”) device, a Plasma Address Liquid Crystal display panel (“PALC”) device, a Liquid Crystal Display (“LCD”) device, a Organic Light Emitting Diode (“OLED”) device, and so on.

Specifically, a typical LCD includes a lower display panel having an array of thin film transistors (“TFTs”), an upper display panel opposed to the lower display panel, and a liquid crystal layer interposed between the upper and lower display panels. In the LCD, an electric field is generated at the liquid crystal layer and the intensity of the electric field is adjusted, thereby manipulating the orientation of the liquid crystal molecules to adjust polarization of light passing therethrough, which is then blocked or emitted to display desired images. The LCD includes a display panel having the upper and lower display panels. Since the display panel is not self-luminescent, i.e., the liquid crystal molecules do not emit light on their own, a light source is necessarily provided in the rear of the display panel to display an image. The LCD display panel adjusts transmittance of light supplied from the light source, thereby displaying an image as discussed briefly above.

A base plate of each of the upper and lower display panels may be a glass substrate. If a surface of the base plate is not uniformly polished, mura patterns, e.g., brightness non-uniformities, may be created on a screen. However, the polishing of the surface of the glass substrate may make the manufacturing process complicated, thereby considerably increasing the production cost. Accordingly, there is a need for a structure that can prevent mura patterns from being inducing on a screen of a display panel without the additional process of polishing the surface of the glass substrate.

### BRIEF SUMMARY OF THE INVENTION

The present invention provides a display panel without mura patterns despite the use of an unpolished glass substrate in the display panel.

The present invention also provides a liquid crystal display having a display panel without mura patterns despite the use of an unpolished glass substrate in the display panel.

The above and other aspects and features of the present invention will be described in or be apparent from the following description of the exemplary embodiments.

According to an exemplary embodiment of the present invention a display panel includes; a first substrate comprising glass and having at least one unpolished surface, a second substrate disposed substantially opposite to the first substrate, a liquid crystal layer interposed between the first substrate and the second substrate, a first polarizing plate disposed on an outer surface of the first substrate and including a diffusion layer, and a second polarizing plate disposed on an outer surface of the second substrate.

According to another exemplary embodiment of the present invention a liquid crystal display includes; a display panel which includes a first substrate comprising glass and having at least one unpolished surface, a second substrate disposed substantially opposed to the first substrate, a liquid crystal layer interposed between the first substrate and the second substrate, a first polarizing plate disposed on an outer surface of the first substrate and including a diffusion layer, and a second polarizing plate disposed on an outer surface of the second substrate, and a light source which supplies the display panel with light.

### BRIEF DESCRIPTION OF THE DRAWINGS

The above and other features and advantages of the present invention will become more apparent by describing in detail exemplary embodiments thereof with reference to the attached drawings in which:

FIG. 1 is a front perspective view of an exemplary embodiment of a display panel according to the present invention;

FIG. 2 is a cross-sectional view of the exemplary embodiment of a display panel, taken along line II-II′ of FIG. 1;

FIG. 3 is an expanded cross-sectional view a first polarizing plate included in the exemplary embodiment of a display panel illustrated in FIG. 1;

FIG. 4 is a schematic cross-sectional view illustrating the path of light passing through the first polarizing plate illustrated in FIG. 3;

FIG. 5 is a schematic cross-sectional view illustrating a modified exemplary embodiment of a first polarizing plate illustrated in FIG. 3;

FIG. 6 is a top plan view of another exemplary embodiment of a display panel according to the present invention;

FIG. 7 is a top plan layout view of the exemplary embodiment of a display panel illustrated in FIG. 6;

FIG. 8 is a cross-sectional view of the exemplary embodiment of a display panel, taken along line B-B′ of FIG. 7; and

FIG. 9 is an expanded view of an area A illustrated in FIG. 8.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative teams are intended to encompass different orientations of the device in use or operation in addition to the orientation depicted in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

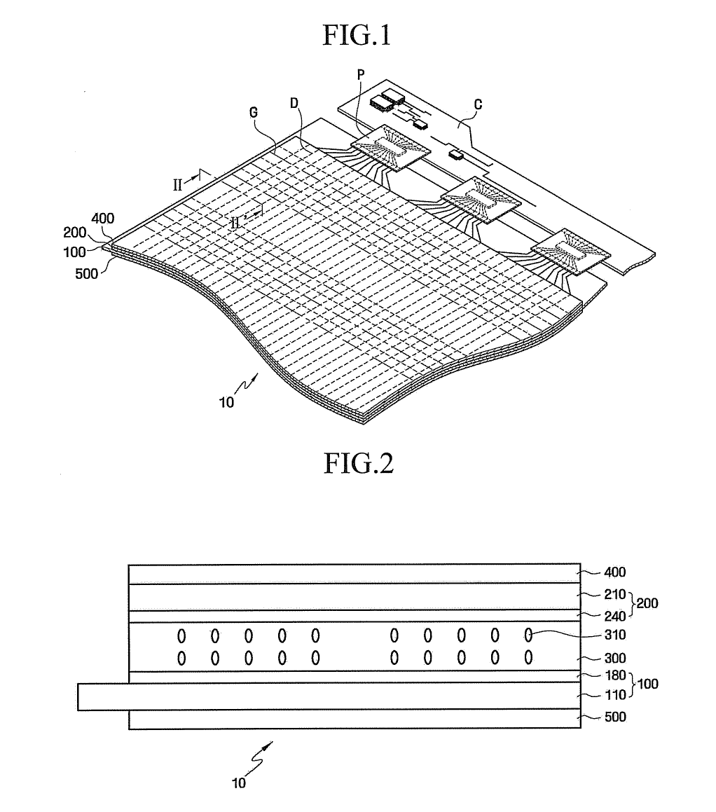

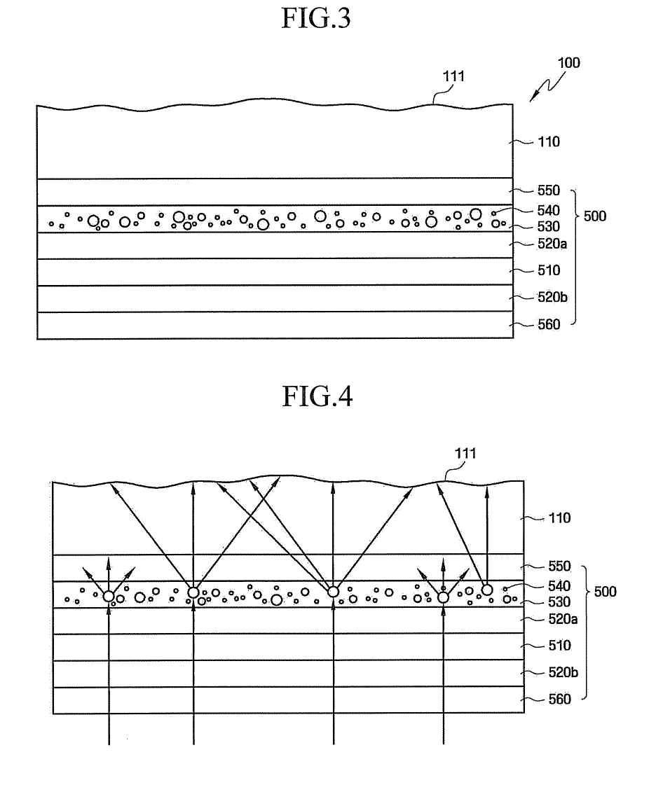

Hereinafter, an exemplary embodiment of a display panel according to the present invention will be described in detail with reference to FIGS. 1 through 4. FIG. 1 is a front perspective view of an exemplary embodiment of a display panel according to the present invention, FIG. 2 is a cross-sectional view of the exemplary embodiment of a display panel, taken along line II-II′ of FIG. 1, FIG. 3 is an expanded cross-sectional view a first polarizing plate included in the exemplary embodiment of a display panel illustrated in FIG. 1, and FIG. 4 is a schematic cross-sectional view illustrating the path of light passing through the first polarizing plate illustrated in FIG. 3.

Referring to FIGS. 1 and 2, an exemplary embodiment of a liquid crystal panel 10 includes an upper display panel 200, a lower display panel 100, and a liquid crystal layer 300 interposed between the lower and upper display panels 100 and 200. A first polarizing plate 500 and a second polarizing plate 400 are disposed on top and bottom surfaces of the lower and upper display panels 100 and 200, respectively.

In one exemplary embodiment, the lower display panel 100 includes a pixel electrode 180 and an array of thin film transistors (“TFTs”) (not shown) individually connected to the pixel electrode 180, and the upper display panel 200 includes a common electrode 240. Exemplary embodiments include configurations wherein the pixel electrode 180 includes a plurality of pixel electrodes (not shown) and wherein each of the plurality of pixel electrodes is individually connected to an individual TFT of the array of TFTs. Alternative exemplary embodiments include configurations wherein the positioning of the pixel electrode 180 and the common electrode 240 may be reversed. An electric field is formed between the lower and upper display panels 100 and 200 and liquid crystal molecules of the liquid crystal layer 300 are rotated to adjust the transmittance of light transmitted through the liquid crystal panel 10, thereby displaying an image.

In one exemplary embodiment, the first polarizing plate 500 and the second polarizing plate 400 may be arranged such that axes of polarizers are substantially perpendicular to each other. If the first polarizing plate 500 and the second polarizing plate 400 are overlapped such that the axes of the polarizing plates 400 and 500 are perpendicular to each other, the incident light passing through the first polarizing plate 500 cannot pass through the second polarizing plate 400. Here, the liquid crystal layer 300 controls the direction of polarization of light having passed through the first polarizing plate 500, and, if necessary, adjusts the amount of light emitted through the second polarizing plate 400.

Exemplary embodiments of the liquid crystal panel 10 can be formed in a twisted nematic (“TN”) liquid crystal mode, or an in-plane switching (“IPS”) liquid crystal mode, according to an alignment state of the liquid crystal molecules. Alternative exemplary embodiments include configurations wherein the liquid crystal panel 10 may be formed in a vertically aligned (“VA”) mode, in which liquid crystal molecules are vertically arranged with respect to a first substrate 110 and a second substrate 210 in a no voltage-applied status. In particular, the VA mode liquid crystal panel has high contrast and suppresses a mura phenomenon induced to the liquid crystal panel 10.

Meanwhile, the mura phenomenon induced to the liquid crystal panel 10 may be caused due to optical interference occurring when light passes through the lower display panel 100, the upper display panel 200, the liquid crystal layer 300, the first polarizing plate 500 and the second polarizing plate 400. In other words, a light traveling path changes while the light passes through the liquid crystal panel 10, and the light is non-uniformly emitted throughout the entire surface of the liquid crystal panel 10 due to optical interference, resulting mura patterns. Accordingly, in order to eliminate the mura patterns from the liquid crystal panel 10, the structure of the liquid crystal panel 10 may be modified.

A distance between the upper display panel 200 and the lower display panel 100 is called a cell gap. One approach to reduce the mura patterns from the liquid crystal panel 10 is to increase the cell gap. That is, the mura patterns of the liquid crystal panel 10 occurring due to optical interference can be reduced by increasing a thickness of the liquid crystal layer 300 disposed between the first substrate 110 and the second substrate 210. In one exemplary embodiment, a distance between the first substrate 110 and the second substrate 210 may be about 4 μm or greater.

The lower display panel 100 having gate lines G and data lines D arranged substantially in a matrix, is formed on the first substrate 110, which in exemplary embodiments may be made of transparent glass. The gate lines G are connected to a gate driver (not shown), and the data lines D are connected to a flexible printed circuit board P and a printed circuit board C. Although the present exemplary embodiment shows the data lines connected to a data driver through the flexible printed circuit board P and the printed circuit board C, alternative exemplary embodiments may include various other configurations for connection, e.g., direct connection, etc.

Exemplary embodiments of the transparent glass substrate used as the first substrate 110 may be formed of a soda-lime glass substrate, a borosilicate glass substrate, a silicate glass substrate, a lead glass substrate, or other materials having similar characteristics. In one exemplary embodiment, the first substrate 110 may be shaped as a rectangle, and may be an unpolished glass substrate. The unpolished glass substrate has an undulating surface, e.g., the surface is not uniformly flat, and there may be a deviation in the overall difference in flatness, e.g., some areas may be more non-uniform than others. The roughness of the glass substrate may be attributable to continuously formed large and small waves, which are generated in the course of manufacturing the glass substrate.

If the first substrate 110 used for the lower display panel 100 is formed of the unpolished glass substrate, exemplary embodiments of the present invention also include a structure for compensating for optical interference. In a case of using an unpolished glass substrate having surface roughness as the first substrate 110, optical interference may occur from incident light generated from a light source (not shown) or natural light, causing mura patterns to the liquid crystal panel 10. As means of compensating for mura patterns caused to the liquid crystal panel 10, a first polarizing plate 500 having an optical diffusing function can be used.

Referring to FIG. 3, the first polarizing plate 500 include a polarization layer 510, a first support layer 520a, a second support layer 520b, a first protective film 550, a second protective film 560, and a diffusion layer 530.

In one exemplary embodiment, the polarization layer 510 may be formed by stretching a film made of polyvinyl alcohol (“PVA”) in one direction and dipping in a dichroic dye solution. Iodine molecules (I₂) and dye molecules are arranged substantially in parallel with the direction of stretching. Since the iodine molecules (I₂) and the dye molecules are dichroic, the polarization layer 510 may absorb light vibrating in the stretched direction, while transmitting the light vibrating in a direction substantially perpendicular to the stretched direction.

In one exemplary embodiment, the polarization layer 510 may be thermally fixed after stretched alignment, and iodine may be evaporated, it can be used without thermal fixation. Accordingly, the polarization layer 510 may be considerably stretched due to a change in the ambient temperature or moisture. In addition, since the polarization layer 510 is mechanically weak with respect to the direction of transmission axis, in one exemplary embodiment the polarization layer 510 uses the first support layer 520a and the second support layer 520b to provide mechanical support. The first support layer 520a and the second support layer 520b constrict the polarization layer 510, thereby restricting deformation due to the change in the ambient temperature or moisture. The first support layer 520a and the second support layer 520b can maintain rigidity of the first polarizing plate 500, and in one exemplary embodiment may be formed of triacetyl cellulous (“TAC”). The first support layer 520a and the second support layer 520b may be attached to top and bottom surfaces of the polarization layer 510, that is, the polarization layer 510 is disposed between the first support layer 520a and the second support layer 520b.

The first polarizing plate 500 is disposed on a bottom surface of the lower display panel 100, and light irradiated from a light source (not shown) is incident into the lower display panel 100 through the first polarizing plate 500. Accordingly, the first polarizing plate 500 is constructed so as to offset mura patterns of the liquid crystal panel 10 due to irregularity of the first substrate 110. The first polarizing plate 500 can diffuse the path of light incident into the lower display panel 100 by forming the diffusion layer 530 on the first support layer 520a.

The optical interference occurs when light beams incident through different paths are combined to then become stronger or weaker, thereby causing a non-uniform brightness of the output light. If the optical interference is induced to the liquid crystal panel 10, mura patterns may appears due to a difference in the brightness of light throughout the liquid crystal panel 10. In order to prevent optical interference, the light having passed the first polarizing plate 500 may be allowed to diffuse in many directions so as not to be weighted toward a particular direction, e.g., the direction of the light through the first polarizing plate 500 is substantially randomized.

The diffusion layer 530 diffuses the light incident from a light source (not shown) into many directions. In one exemplary embodiment, the diffusion layer 530 may include scattered particles 540. In one exemplary embodiment, silica gel or polystyrene particles may be used as the scattered particles 540. In one exemplary embodiment, the diffusion layer 530 may be formed by coating the scattered particles 540 mixed with an acryl resin or polyethylen terephthalate (“PET”) in a gel state on the first support layer 520a or the first protective film 550. The scattered particles 540 can be uniformly or non-uniformly distributed throughout the diffusion layer 530, and may include varying particle sizes.

The scattered particles 540 may be used for irregular reflection or irregular refraction of the incident light into the diffusion layer 530. In one exemplary embodiment, the density of the scattered particles 540 may vary throughout the diffusion layer 530. In another exemplary embodiment, the density of the scattered particles 540 may themselves vary, e.g., one particle 540 may be denser than another particle 540.

The first protective film 550 and the second protective film 560 may be attached to the outermost surface of the first polarizing plate 500. The first protective film 550 and the second protective film 560 protect a surface of the first polarizing plate 500 when the liquid crystal panel 10 is subjected to various processing steps, including a failure test, a TAB process, a PCB process, and so on.

In one exemplary embodiment, the first protective film 550 and the second protective film 560 may be peeled off for removal when the first polarizing plate 500 is attached to the liquid crystal panel 10 or when the assembling process of the liquid crystal panel 10 is completed.

The first protective film 550 and the second protective film 560 may be films, exemplary embodiments of which may be made of an optically transparent polymer resin including, but not limited to, a transparent polyethylene terephthalate (“PET”) resin, a polyolefin resin, a polyester resin, a polyacryl resin, and a polycarbonate (“PC”) resin.

The second polarizing plate 400 is disposed at the outer surface of the upper display panel 200. As described above, the first polarizing plate 500 and the second polarizing plate 400 may be disposed such that polarization axes thereof are orthogonal to each other. The second polarizing plate 400 may have substantially the same structure as the first polarizing plate 500 except that the first and second polarizing plates 500 and 400 are disposed such that polarization axes thereof are different from each other.

Here, the diffusion layer 530 of the first polarizing plate 500 may function like the anti-glare layer in the second polarizing plate 400. The first polarizing plate 500 is formed substantially at the outermost layer of the liquid crystal panel 10, so that it may serve as a reflective surface at which externally incident light is reflected. The diffusion layer 530 acting as an anti-glare layer may have an undulating surface (not shown) thereby providing irregular reflection so that the light incident in a given direction may not be reflected in a particular direction. In such an exemplary embodiment, a protective film, e.g., the first protective film 550 of the first polarizing plate 500, may not be necessary. An anti-glare layer (not shown) may be formed on the outer surface of the protective film 550.

Meanwhile, the second polarizing plate 400 may further include a compensation layer (not shown) for compensating for a phase difference by the light having passed through the liquid crystal layer 300. Exemplary embodiments of the compensation layer may be a phase difference compensating film formed of a 1-axis alignment film of polycarbonate.

Referring to FIG. 4, an optical path of light incident through the first polarizing plate 500 will be described. The light irradiated from a light source (not shown) is first incident into the first polarizing plate 500. Then, the incident light entering the first polarizing plate 500 passes through the second protective film 560 and the second support layer 520b to then be incident into the polarization layer 510. Here, the light beams having passed through the second protective film 560 and the second support layer 520b are not polarized but travel straightforward and penetrate the second protective film 560 and the second support layer 520b without being reflected.

The polarization layer 510 polarizes incident light irradiated from a light source (not shown) into light of substantially the same direction substantially parallel with polarization axes, e.g., light having a polarization substantially perpendicular to the polarization axes of the polarization layer 510 is absorbed thereby.

While passing through the polarization layer 510, the light is polarized in the same direction of the polarization axis of the polarization layer 510. The light polarized in the same direction with the polarization layer 510 passes through the first support layer 520a to then be incident into the diffusion layer 530.

Here, the incident light entering the diffusion layer 530 collides with the scattered particles 540, so that some of the incident light may penetrate the scattered particles 540 and some may be reflected by the scattered particles 540. As a result, the optical paths may be refracted and scattered. As described above, the scattered particles 540 vary in terms of particle size and density and the incident light is refracted in an arbitrary direction. That is to say, the light scattered by the scattered particles 540 does not have regular or predominantly oriented direction, unlike the initial incident light. Accordingly, even after passing through an undulating surface 111 of the first substrate 110, the scattered light entering the first substrate 110 can avoid optical interference created due to the undulating surface 111. That is to say, since the first polarizing plate 500 attached to the outer surface of the first substrate 110 includes the diffusion layer 530 for diffusing light to the first polarizing plate 500, even if an unpolished glass substrate is used as the first substrate 110, it is possible to prevent mura patterns from appearing on the liquid crystal panel 10.

Meanwhile, as discussed briefly above, the mura patterns appearing on the liquid crystal panel 10 can also be effectively prevented by increasing a cell gap corresponding to a distance between the first substrate 110 and the second substrate 210 using the first polarizing plate 500 including the diffusion layer 530, and making orientation of the liquid crystal molecules 310 be substantially perpendicular to the first substrate 110 and the second substrate 210.

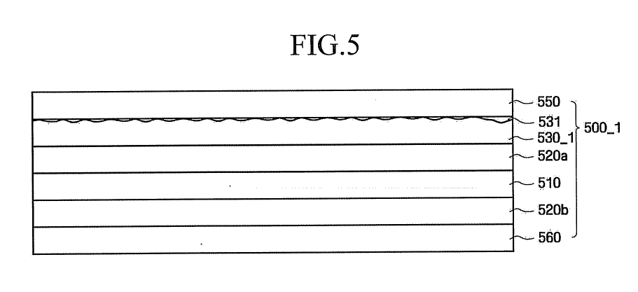

Hereinafter, a modified exemplary embodiment of the first polarizing plate will be described with reference to FIG. 5. FIG. 5 is a schematic cross-sectional view illustrating a modified exemplary embodiment of the first polarizing plate illustrated in FIG. 3.

Referring to FIG. 5, a modified first polarizing plate 500_1 includes a diffusion layer 530_1 having a micro-undulated surface 531. The micro-undulated surface 531 of the diffusion layer 530_1 induces irregular reflection or irregular refraction to its surface. In one exemplary embodiment, the micro-undulated surface 531 may be formed in a random direction, e.g., the undulations may be substantially random in size and direction.

Incident light entering the first polarizing plate 500_1 is polarized by the polarization layer 510 in a polarization axis direction of the first polarizing plate 500, and then scattered in many directions while passing through the diffusion layer 530_1. In other words, the micro-undulated surface 531 formed on a surface of the diffusion layer 530_1 induces irregular reflection or irregular refraction of light. Thus, the light entering in a predetermined direction loses directionality while passing through the micro-undulated surface 531, and turns into scattered light. The scattered light can prevent mura patterns from appearing on the liquid crystal panel 10 even after it passes through the first substrate 110 made of unpolished glass.

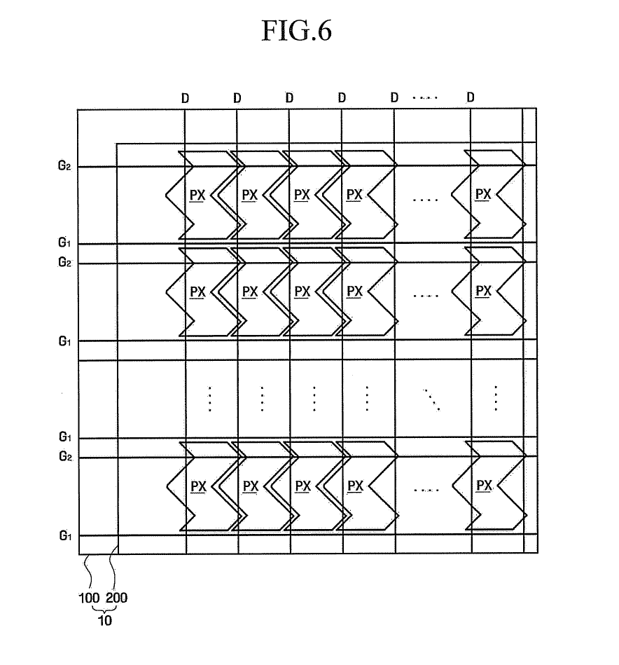

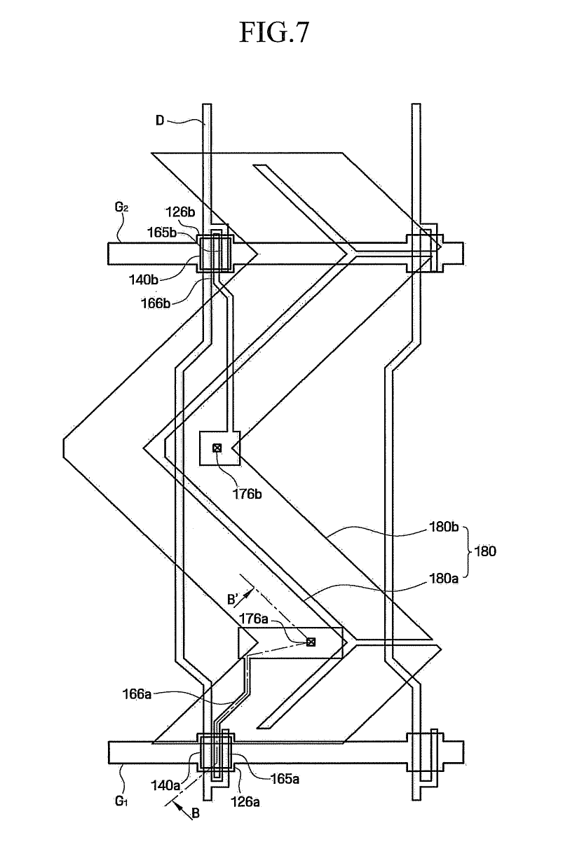

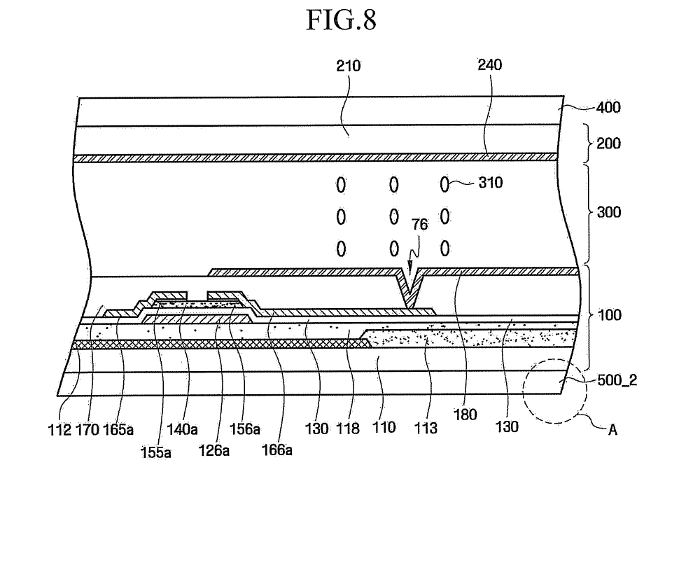

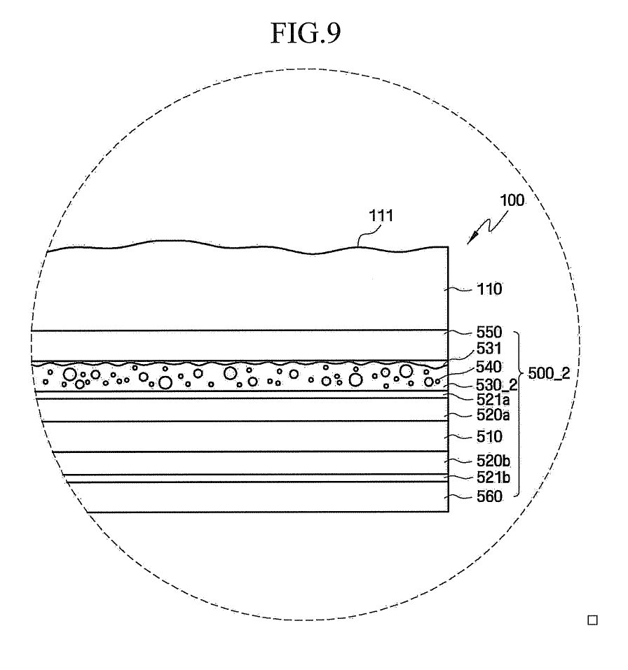

Hereinafter, another exemplary embodiment of a display panel according to the present invention will be described in detail with reference to FIGS. 6 through 9. FIG. 6 is a top plan view of another exemplary embodiment of a display panel according to the present invention, FIG. 7 is a top plan layout view of the exemplary embodiment of a display panel illustrated in FIG. 6, FIG. 8 is a cross-sectional view of the exemplary embodiment of a display panel, taken along line B-B′ of FIG. 7, and FIG. 9 is an expanded view of an area A illustrated in FIG. 8.

The liquid crystal panel 10 includes a first polarizing plate 500_2 having a micro-undulated surface 531 and scattered particles 540, and pixels having a high aperture ratio. In addition, a color filter 113 and a black matrix 112 are provided on a lower display panel 100 in order to prevent alignment errors during manufacturing. Alternative exemplary embodiments include embodiments wherein the color filter 113 and black matrix 112 are disposed on the upper display panel 200.

First, referring to FIG. 6, the liquid crystal panel 10 includes a plurality of gate lines G transmitting gate signals and data lines D transmitting data signals. The gate lines G and the data lines D are arranged so as to be substantially perpendicular to each other and form a matrix type arrangement. In the present exemplary embodiment, the gate lines G are formed in pairs for each pixel PX. Each pixel PX may be partitioned into multiple domains. That is, each pixel PX has one data line D and two gate lines G to drive two switching elements. The two switching elements control the pixel PX partitioned into multiple domains. Alternative exemplary embodiments include configurations wherein only a single domain is formed and only a single data lines is used.

Meanwhile, pixels PX may be arranged along the data line D in a zigzag shape. As the pixels PX are arranged along the data line D in the zigzag shape, an effective opening area of the liquid crystal panel 10 is increased, thereby increasing the overall aperture ratio. The pixels PX may function as slits formed in the liquid crystal panel 10, affecting optical interference. Accordingly, it is possible to prevent mura patterns from appearing on the liquid crystal panel 10 by arranging the pixels PX in the zigzag shape.

A structure of an individual pixel will be described in detail with reference to FIGS. 7 and 8.

The lower display panel 100 includes a first gate line G, a second gate line G, data lines D, a first sub-pixel electrode 180a and a second sub-pixel electrode 180b.

Black matrices 112 substantially surround a pixel area and are formed on the first substrate 110, which in the present exemplary embodiment may be made of unpolished soda-lime glass. The black matrices 112 serve as light blocking films preventing light leakage into areas other than the pixel area. The black matrices 112 expose the pixel area formed along the data lines D in a zigzag shape, e.g., they allow light to pass through the pixel area.

Color filters 113 are formed on the pixel area between the black matrices 112. The color filters 113 overlap a pixel electrode 180 formed on the pixel area between the black matrices 112 and red R, green G, and blue B color filters 113 may be sequentially arranged on the pixel area. An overcoat layer 118 may be formed on the R, G, and B color filters 113 in order to planarize their step heights.

The overcoat layer 118 has first and second gate lines G formed thereon to extend in a predetermined direction, e.g., in a transverse direction. The first and second gate lines G include first and second gate electrodes 126a and 126b, respectively. In one exemplary embodiment, the first and second gate lines G and the first and second gate electrodes 126a and 126b may be formed to overlap the black matrices 112. A gate insulating layer 130 is formed on the first and second gate lines G and the first and second gate electrodes 126a and 126b.

A pair of semiconductor layers 140a and 140b, exemplary embodiments of which may be made of hydrogenated amorphous silicon or polysilicon, are formed on the gate insulating layer 130.

Ohmic contact layers 155a and 155b, exemplary embodiments of which may be made of a substance such as silicide or n+ hydrogenated amorphous silicon in which an n-type impurity is doped at a high concentration, are formed on the semiconductor layers 140a and 140b. The ohmic contact layers 155a and 155b are formed in pair on the semiconductor layers 140a and 140b. Alternative exemplary embodiments include configurations wherein the ohmic contact layers 155a and 155b may be omitted.

The data lines D extend in a predetermined direction, e.g., a longitudinal direction, to be substantially perpendicular to the first and second gate lines G for transmission of data voltages. First and second source electrodes 165a and 165b extending toward the first and second drain electrodes 166a and 166b are formed along the data lines D, e.g., first and second source electrodes 165a and 165b are formed on each individual data line D.

A pair of first and second drain electrodes 166a and 166b corresponding to the first and second source electrodes 165a and 165b, respectively, are formed on the ohmic contact layers 155a and 156a, respectively, and the gate insulating layer 130.

Each pixel is divided into a pair of sub-pixels, the first drain electrode 166a transmits a data signal to the first sub-pixel electrode 180a, and the second drain electrode 166b transmits another data signal to the second sub-pixel electrode 180b.

The first and second gate electrodes 126a and 126b, the first and second source electrodes 165a and 165b, and the first and second drain electrodes 166a and 166b constitute three terminals of a TFT. The TFT functions as a switching element for controlling the first sub-pixel electrode 180a and the second sub-pixel electrode 180b. In one exemplary embodiment, the switching element and the data lines D may be formed to overlap the black matrices 112.

A passivation layer 170, exemplary embodiments of which may be made of an insulating material, is formed on the data lines D, the first and second drain electrodes 166a and 166b, and exposed portions of the semiconductor layers 140a and 140b. A pixel electrode 180, including the first and second sub-pixel electrodes 180a and 180b, is electrically connected to the first and second drain electrodes 166a and 166b through first and second contact holes 176a and 176b formed in the passivation layer 170, respectively.

Meanwhile, the first and second sub-pixel electrodes 180a and 180b are formed on the pixel area. In the present exemplary embodiment, the first and second sub-pixel electrodes 180a and 180b are made of a transparent conductive material, exemplary embodiments of which include Indium Tin Oxide (“ITO”), Indium Zinc Oxide (“IZO”), a reflective conductive material such as aluminum (Al), or other materials having similar characteristics.

The first and second sub-pixel electrodes 180a and 180b are physically and electrically connected to the first and second drain electrodes 166a and 166b through the first and second contact holes 176a and 176b, and receive different data voltages from the first and second drain electrodes 166a and 166b, respectively.

The first sub-pixel electrode 180a and the second sub-pixel electrode 180b may be formed to overlap with the first and second gate lines G1 and G2. The first sub-pixel electrode 180a and the second sub-pixel electrode 180b are bent in a zigzag shape. The first and second gate lines G1 and G2 are formed at bent portions of the first sub-pixel electrode 180a and the second sub-pixel electrode 180b, thereby reducing the aperture ratio.

In one exemplary embodiment, the second sub-pixel electrode 180b may be formed to substantially surround the first sub-pixel electrode 180a. The first sub-pixel electrode 180a and the second sub-pixel electrode 180b are supplied with different data voltages, thereby increasing visibility. The first sub-pixel electrode 180a and the second sub-pixel electrode 180b can be independently driven.

The upper display panel 200 is located to face the lower display panel 100, and a liquid crystal layer 300 is disposed between the upper display panel 200 and the lower display panel 100. The upper display panel 200 includes a common electrode 240. The common electrode 240 may be formed on the second substrate 210.

The liquid crystal panel 10 according to another exemplary embodiment of the present invention has a color filter on array (“COA”) structure in which a thin film transistor (“TFT”) array is formed on the color filters 113. In the COA structure, all components except for the common electrode 240 are formed on the lower display panel 100. In the COA structure, even when unpolished glass substrate is used as the first substrate 110, it is possible to prevent mura patterns from appearing on the liquid crystal panel 10 due to optical interference. The structure capable of preventing the mura patterns from appearing on the liquid crystal panel 10 is not limited to the COA structure of the illustrated embodiment, and an array on color filter (“AOC”) structure can also be applied to the invention.

Referring to FIG. 9, the first polarizing plate 5002 is disposed at the outer surface of the lower display panel 100. As described above, the first polarizing plate 500_2 includes a diffusion layer 530_2. The diffusion layer 5302 has a micro-undulated surface 531 on its top surface. The micro-undulated surface 531 of the diffusion layer 530_2 induces irregular reflection or irregular refraction to its surface for diffusing light. In addition, the diffusion layer 530_2 includes scattered particles 540 for scattering light. The scattered particles 540 sufficiently scatter light in cooperation with the micro-undulated surface 531 to prevent the formation of mura patterns on the liquid crystal panel 10.

The diffusion layer 530_2 includes a compensating film 521a and 521b disposed on an outer surface of one of the first support layer 520a and the second support layer 520b. The compensating film 521a and 521b may include one of a view-angle compensating film, a phase compensating film and a color compensating film.

In conclusion, since the liquid crystal panel 10 according to the present invention is configured such that the lower display panel 100 has a COA or AOC structure, the pixel electrode 180 is formed in a zigzag shape to achieve a high aperture ratio, and the first polarizing plate 5002 includes the diffusion layer 530_2, a mura phenomenon due to optical interference can also be effectively prevented even when an unpolished glass substrate is used as the first substrate 110.

A liquid crystal display can be fabricated using a light source (not shown) as a backlight supplying the display panel 10 with light.

While the present invention has been particularly illustrated and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A display panel comprising:
a first substrate comprising glass and having at least one unpolished surface;
a second substrate disposed substantially opposite to the first substrate;
a liquid crystal layer interposed between the first substrate and the second substrate;
a first polarizing plate disposed on an outer surface of the first substrate and including a diffusion layer; and
a second polarizing plate disposed on an outer surface of the second substrate.

2. The display panel of claim 1, wherein the first polarizing plate comprises:
a polarization layer which polarizes light; and
a first support layer disposed on a first surface of the polarization layer; and
a second support layer disposed on a second surface of the polarization layer substantially opposite the first support layer,
wherein the diffusion layer includes scattered particles and is disposed on an outer surface of the first support layer substantially opposite to the polarization layer.

3. The display panel of claim 2, wherein the scattered particles comprise silica gel.

4. The display panel of claim 1, wherein the diffusion layer has an irregular surface on its surface which causes at least one of irregular reflection and irregular refraction of light passing therethrough.

5. The display panel of claim 1, further comprising a protective film disposed on an outer surface of the diffusion layer.

6. The display panel of claim 1, further comprising a compensating film disposed on an outer surface of one of the first support layer and the second support layer.

7. The display panel of claim 1, wherein polarization axes of the first polarizing plate and the second polarizing plate are substantially orthogonal to each other.

8. The display panel of claim 1, wherein a direction of alignment of the liquid crystal layer is substantially perpendicular to the first substrate the second substrate in a state wherein an electric is not applied thereto.

9. The display panel of claim 1, wherein a distance between the first substrate and the second substrate is about 4 μm or greater.

10. The display panel of claim 1, further comprising:
gate lines disposed on the first substrate;
data lines disposed on the first substrate substantially perpendicular to the gate lines; and
pixel electrodes connected to the gate lines and the data lines through a plurality of switching elements and disposed extending substantially along the data lines in a zigzag shape.

11. The display panel of claim 10, further comprising a color filter disposed on the first substrate and overlapping at least one of the pixel electrodes.

12. The display panel of claim 10, further comprising a black matrix disposed on the first substrate and overlapping the gate line, the data line and the plurality of switching elements.

13. The display panel of claim 1, wherein the first substrate comprises soda-lime glass.

14. A liquid crystal display comprising:
a display panel which includes:
a first substrate comprising glass and having at least one unpolished surface;
a second substrate disposed substantially opposite to the first substrate;
a liquid crystal layer interposed between the first substrate and the second substrate;
a first polarizing plate disposed on an outer surface of the first substrate and including a diffusion layer; and
a second polarizing plate disposed on an outer surface of the second substrate; and
a light source which supplies the display panel with light.

15. The liquid crystal display of claim 14, wherein the first polarizing plate comprises:
a polarization layer which polarizes light; and
a first support layer disposed at a first surfaces of the polarization layer; and
a second support layer disposed on a second surface of the polarization layer substantially opposite to the first support layer,
wherein the diffusion layer includes scattered particles and is disposed on an outer surface of the first support layer.

16. The liquid crystal display of claim 14, wherein the scattered particles comprise silica gel.

17. The liquid crystal display of claim 14, wherein the diffusion layer has an irregular surface which causes at least one of irregular reflection and irregular refraction of light passing therethrough.

18. The liquid crystal display of claim 14, further comprising:
gate lines disposed on the first substrate;
data lines disposed on the first substrate substantially perpendicular to the gate lines; and
pixel electrodes connected to the gate lines and the data lines through a plurality of switching elements and disposed extending substantially along the data lines in a zigzag shape.

19. The liquid crystal display of claim 18, further comprising a color filter disposed on the first substrate and overlapping at least one of the pixel electrodes.

20. The liquid crystal display of claim 18, further comprising a black matrix disposed on the first substrate and overlapping the gate line, the data line and the plurality of switching elements.

21. The liquid crystal display of claim 14, wherein the first substrate comprises soda-lime glass.
